(19) United States
(12) Patent Application Publication
(10) Pub. No.: US 2009/0224000 A1
(43) Pub. Date: Sep. 10, 2009

(54) DEVICE FOR DISPENSING LIQUIDS

(75) Inventors: Jose Luis Castello LOPEZ, Beniparrel (ES); Cerefino Juarez PINTO, Beniparrel (ES)

Correspondence Address: SUGHRUE MION, PLLC, 2100 PENNSYLVANIA AVENUE, N.W., SUITE 800, WASHINGTON, DC, 20037, US

(73) Assignee: NEW CELLARS CLIMATIC, S.L., Beniparrel (ES)

(21) Appl. No.: 12/340,071

(22) Filed: Dec. 19, 2008

(30) Foreign Application Priority Data
Mar. 10, 2008 (ES) U200800496

(51) Int. Cl. B67D 1/08; B65D 83/00

(52) U.S. Cl. 222/152; 222/399

(57) ABSTRACT

Device for dispensing liquids allowing the controlled metering of the liquid by introducing nitrogen gas into the container containing it, preventing at the same time the oxidation and the deterioration of the liquid remaining in the container. The device having a system for coupling to the neck of the container which allows the device to be used simply and practically, offering a perfectly airtight coupling and optimum aesthetic features, being especially applicable in the industry for the metering of controlled amounts of bottled wine into stem glasses.

### OBJECT OF THE INVENTION

This invention relates to a device for dispensing liquids allowing the controlled metering of said liquid by means of introducing a gas, nitrogen or argon, into the container containing it, preventing at the same time the oxidation and the deterioration of the liquid remaining in the container, having a system for coupling to the neck of the container which allows the device to be used simply and practically, offering a perfectly airtight coupling and optimum aesthetic features, being especially applicable in the industry for the metering of controlled amounts of bottled wine into stem glasses.

### BACKGROUND OF THE INVENTION

There are currently various methods which allow metering in a controlled manner the liquid contained in containers, usually bottles, for its dispensing into glasses or stem glasses, among which siphon-type dispensers are noteworthy.

Spanish utility model number ES 278 797 U describes a liquid-dispensing stopper consisting of a flexible part having an expansion with a pear-shaped configuration extending at the lower part in a conduit from which there laterally extends a hollow appendage with a curved configuration, through which the liquid to be dispensed is extracted. In its lower part, said conduit has a section with a frustoconical configuration having a plurality of circular reliefs allowing the stopper to be introduced into the neck of a bottle.

By means of this stopper, to extract the liquid, the upper expansion is pressed, which causes a negative pressure causing the upward movement of the liquid through a conduit that is introduced in the liquid, as well as its exit to the outside through the hollow appendage with a curved configuration.

Among the drawbacks of this device it must be mentioned that given its suction system, the entrance of air and thus the deterioration of the contained liquid, due to the oxidation it experiences, occurs, in addition to the fact that it does not allow controlling the dose of liquid dispensed.

In addition, there are devices having complex means for coupling them to the neck of the bottle which comprise a large amount of elements, increasing their manufacturing costs and making them more complicated to use, causing a coupling in non air-tight conditions when it is incorrectly placed, which often happens when it is placed quickly, for example by a waiter in the hotel and catering business.

These devices comprise an outer sleeve which requires being placed at its lower mouth at the outer part of the neck, carrying out a vertical downward movement to a suitable depth at which a clamp system surpasses an ring-shaped rib located on the neck of the bottle, all this at the same time as the elements for the inner coupling to the neck of the container fall into place on the inside. After this delicate operation, these devices require a locknut to be manually tightened, to act on the inner clamp, such that the device is correctly coupled to the container.

The drawbacks of these devices are that they require special attention for their coupling to the container, in addition to the fact that they are complicated and comprise a large number of elements, which increases their production costs, the possibility of failure in the coupling increasing as it comprises a single coupling means, which in the event of not being suitably fitted, renders the loss of the airtight effect of the coupling and the correct operation of the device useless.

### DESCRIPTION OF THE INVENTION

This invention relates to a device for dispensing liquids allowing the controlled metering of a liquid contained in a container, such as for example bottled wine, by means of injecting gas, argon or nitrogen, into the container, preventing the oxidation of the liquid remaining in the container, having means for coupling to the container allowing a simple, practical and effective use of the device, offering a coupling in completely airtight conditions.

The device for dispensing liquids proposed by the invention comprises a hollow tube which is introduced down to a lower area or bottom of a container containing a liquid, preferably consisting of a bottle. Said tube has an upper bent section allowing the dispensed liquid to come out into a glass or stem glass placed in a substantially vertical position.

The device likewise comprises a gas injector designed to inject controlled doses of gas into a hollow area of the container and cause the dispensing of controlled doses of the liquid contained in said container through said tube. To that end, the gas injector comprises a trigger acting on a bypass valve having a nitrogen gas tank, which is preferably disposable and replaceable after use, and being protected by means of its housing in a casing and having a grip support so that the user who acts on the trigger can support his or her finger. The gas can be argon, nitrogen or gas with similar properties.

Therefore, according to the invention, the device comprises a hollow injector body traversed by the tube in an airtight fashion, said injector body comprising an outer section located outside the container and in which there is coupled a lateral injection conduit of the gas injector, being communicated with the hollow interior of the injector body.

Said injector body likewise comprises an inner section with a generally cylindrical configuration configured to be introduced into the neck of the container, where said inner section of the injector body comprises at least two elastic retainers comprising a plurality of ring-shaped ribs, preferably made of rubber, configured to couple the inner section of the injector body to the neck of the container in an airtight fashion, forming at least one double air-tightness means allowing the device to be quickly and simply placed in a container.

The injected gas is preferably argon or pure nitrogen, which is supplied in individual capsules for a single use in one container or in several containers, according to the volume of the container, being disposable after their use, at which time they can be pierced. The injected gas is introduced in the container under pressure, it therefore floods or fills the empty or hollow part of the container, i.e., the non-liquid part located at the upper part in the container due to the effect of gravity when the container is maintained in a substantially vertical position, it therefore pushes the liquid towards the lower area of the container due to an expansion effect, causing it to exit through the lower end of the tube, which is located in said lower area inside the container. The dispensing is carried out in a controlled manner, to which end the bypass valve controlling the opening and closing of the gas expansion circuit is acted on by means of the trigger.

The conduit through which gas is injected and the liquid extraction or exit tube are independent and are not communicated.

It is contemplated that the device comprises an o-ring seal, located above the outer section of the injector body, configured to be fitted and coupled to the tube in an airtight fashion, which allows at least one triple means for ensuring that the device is airtight.

It is likewise contemplated that the device comprises a locknut located above the outer section of the injector body, configured to adjust the position of the tube with respect to the injector body.

Thus, according to the described invention, the device for dispensing liquids proposed by the invention represents an advance in dispensers used until now, and fully and satisfactorily solves the problems described above in the sense of allowing the controlled dispensing of doses of wine contained in a bottle into stem glasses and/or glasses by means of introducing gas, argon or nitrogen, into the bottle, preventing at the same time the oxidation of the bottled wine, having a coupling to the neck of the bottle allowing a simple and practical use, offering an airtight coupling and optimal aesthetic features.

The device allows dispensing a dose of wine in a controlled manner, controlling the amount of liquid extracted, being a portable and autonomous device configured to be coupled to any type of vessel or container containing a liquid to be dispensed, such as bottled wine, for example.

The device allows wine to be kept at room temperature or chilled, maintaining the remaining liquid contained in the container in optimal antioxidant conditions, preventing its deterioration until the time it is extracted from the container. The liquid contained in the container is thus completely extracted, such that the non-liquid volume contained in the container is flooded with a gas, argon or nitrogen, atmosphere preventing the oxidation of the liquid, as it expels air from the interior, i.e., an oxygen atmosphere favoring the oxidation of the liquid and therefore its deterioration.

### BRIEF DESCRIPTION OF THE DRAWINGS

To complement the description being made and with the aim of aiding to better understand the features of the invention according to a preferred practical embodiment thereof, a set of drawings is attached to the following specification which complement the description of a preferred embodiment that will be made below, their contents not being limiting but merely illustrative.

FIG. 1 shows an exploded view of the elements comprised by a preferred embodiment of the device for dispensing liquids proposed by the invention.

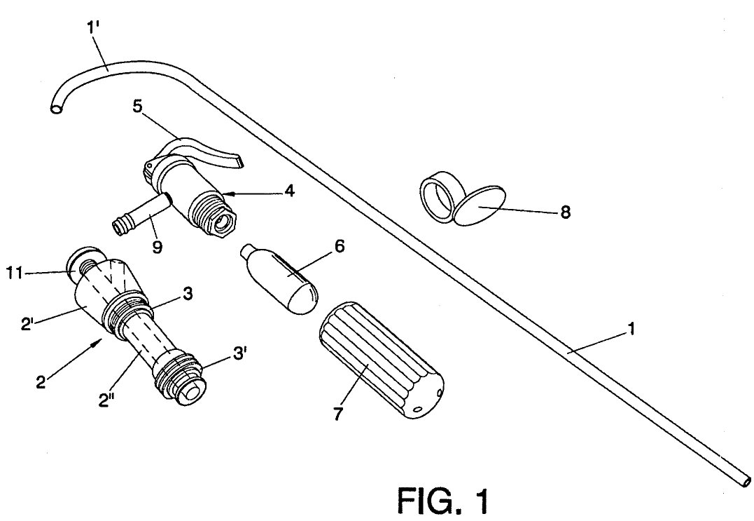

FIG. 2 shows a perspective view of the device of the invention placed in the neck of a container.

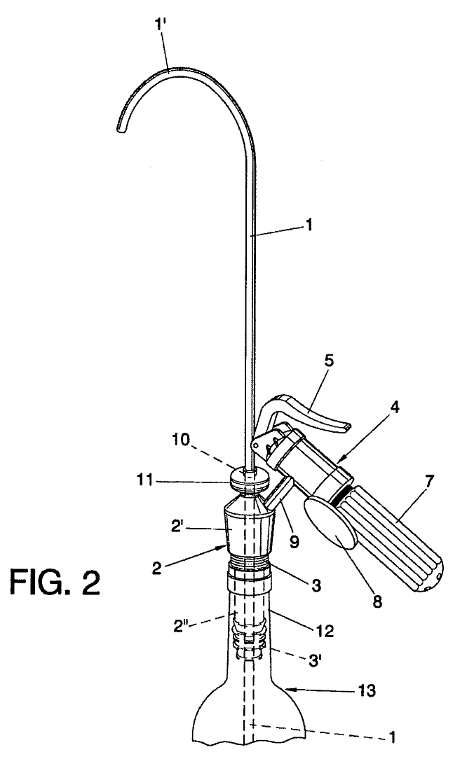

### DESCRIPTION OF A PREFERRED EMBODIMENT OF THE INVENTION

In view of the indicated figures, it can be observed how in one of the possible embodiments of the invention, the device for dispensing liquids proposed by the invention comprises a hollow tube (1) which is introduced down to a lower area of a container (13) consisting of a bottle containing wine. Said tube (1) has an upper bent section (1′) allowing the dispensed liquid to come out into a glass or stem glass placed in a substantially vertical position.

The device comprises a gas, argon or nitrogen, injector (4) configured to inject controlled doses of nitrogen gas into a hollow area of the container (13) and cause the dispensing of controlled doses of the liquid contained in said container (13) through said tube (1). To that end, the gas injector (4) comprises a trigger (5) acting on a bypass valve having a nitrogen gas tank (6) which is disposable and replaceable after its use, being protected by being of its housing in a casing (7), ad having a grip support (8) so that the user who acts on the trigger (5) can support his or her finger.

The device therefore comprises a hollow injector body (2) which is traversed by the tube (1) in an airtight fashion, said injector body (2) comprising an outer section (2′) which is located outside the container (13) and in which there is coupled a lateral injection conduit (9) of the gas injector (4), being communicated with the hollow interior of the injector body (2).

Likewise, said injector body (2) comprises an inner section (2″) with a generally cylindrical configuration configured to be introduced in a neck (12) of the container (13), where said inner section (2″) of the injector body (2) comprises two elastic retainers (3, 3′) comprising a plurality of ring-shaped rubber ribs to couple the inner section (2″) of the injector body (2) to the neck (12) of the container (13) in an airtight fashion, forming at least one double means of air-tightness allowing the device to be placed quickly and simply in a container (13).

The inner section (2″) of the injector body (2) specifically comprises an upper elastic retainer (3) configured to be located at the level of a mouth of the container (13) and a lower elastic concentric retainer (3′) configured to be internally located in the neck (12) of said container (13).

The device comprises an o-ring seal (10) located above the outer section (2′) of the injector body (2), configured to be fitted and coupled in an airtight fashion to the tube (1), which allows at least one triple means for ensuring that the device is airtight.

The device likewise comprises a locknut (11) located above the outer section (2′) of the injector body (2), configured to adjust the position of the tube (1) with respect to the injector body (2).

In view of this description and set of drawings, a person skilled in the art will be able to understand that the embodiments of the invention which have been described can be combined in many ways within the object of the invention. The invention has been described according to several preferred embodiments thereof, but for a person skilled in the art it will be evident that many variations may be introduced in said preferred embodiments without exceeding the object of the claimed invention.

1. A device for dispensing liquids, comprising a tube (1) that is introduced down to a lower area of a container (13) containing a liquid, comprising a gas injector (4) configured to inject controlled doses of gas into a hollow area of the container (13) and cause the dispensing of controlled doses of the liquid contained in said container (13) through said tube (1), characterised in that it comprises an injector body (2) which is traversed by the tube (1) in an air-tight fashion, said injector body (2) comprising an outer section (2′), in which there is coupled a lateral injection conduit (9) of the gas injector (4), and an inner section (2″) with a generally cylindrical configuration configured to be introduced in a neck (12) of the container (13), wherein said inner section (2″) of the injector body (2) comprises at least two elastic retainers (3, 3′) comprising a plurality of ring-shaped ribs configured to couple the inner section (2″) of the injector body (2) to the neck (12) of the container (13) in an airtight fashion.

2. The device for dispensing liquids according to claim 1, characterised in that the inner section (2″) of the injector body (2) comprises an upper elastic retainer (3) configured to be located at the level of a mouth of the container (13) and a lower elastic retainer (3′) configured to be internally located in the neck (12) of said container (13).

3. The device for dispensing liquids according to claim 1, characterised in that it comprises an o-ring seal (10) located above the outer section (2′) of the injector body (2), configured to be fitted and coupled to the tube (1) in an airtight fashion.

4. The device for dispensing liquids according to claim 3, characterised in that it comprises a locknut (11) located above the outer section (2′) of the injector body (2), configured to adjust the position of the tube (1) with respect to the injector body (2).

5. Device, according to claim 1, characterized because the gas is argon.

6. Device, according to claim 1, characterized because the gas is nitrogen.
